(19) United States
(12) Patent Application Publication
(10) Pub. No.: US 2008/0068712 A1
(43) Pub. Date: Mar. 20, 2008

(54) Polarization Beam Source

(75) Inventors: Chen Yang Huang, Hsinchu County (TW); Cheng Wei Chu, Taipei County (TW)

Correspondence Address: WPAT, PC;INTELLECTUAL PROPERTY ATTORNEYS, 2030 MAIN STREET, SUITE 1300, IRVINE, CA, 92614, US

(73) Assignee: Industrial Technology Research Institute, Hsinchu County (TW)

(21) Appl. No.: 11/554,988

(22) Filed: Oct. 31, 2006

(30) Foreign Application Priority Data
Sep. 20, 2006 (TW) 095134729

(51) Int. Cl. G02B 27/28

(52) U.S. Cl. 359/487; 359/483

(57) ABSTRACT

A polarization beam source comprises a reflective base, at least one light-emitting device positioned on the reflective base and configured to emit lights, a fluorescent material positioned on the light-emitting device to generate an unpolarized light and a polarization beam splitter configured to reflect a first polarization beam of the unpolarized light and allow a second polarization beam of the unpolarized light to transmit to the exterior of the polarization beam source. The polarizing beam splitter includes a first substrate and a plurality of line-shaped protrusions positioned on the first substrate. The lights emitted from the light-emitting chip are used to irradiate the fluorescent material to generate the unpolarized light, and the polarizing beam splitter reflects the first polarizing beam to the fluorescent material and allows the second polarizing beam to transmit to the exterior of the polarization light source.

### BACKGROUND OF THE INVENTION

(A) Field of the Invention

The present invention relates to a polarization beam source, and more particularly, to a polarization beam source using a light-emitting device and a grating polarization beam splitter (PBS).

(B) Description of the Related Art

FIG. 1 illustrates a conventional light-emitting device 10. The light-emitting device 10 includes a substrate 12, a light-emitting diode chip 14 positioned on the substrate 12, a fluorescent material 16 having a refractive index of approximately 1.5-1.6 on the light-emitting diode chip 14 and a transparent cover 18 having a refractive index of approximately 1.5. The light 20 (e.g. ultraviolet light) generated by the light-emitting diode chip 14 excites the fluorescent material 16 (e.g. red, green, blue fluorescent material) to generate red, green and blue excited lights 22, which mix to generate a white light 24. Particularly, the excited lights 22 emitted from the light-emitting device 10 are unpolarized lights including a P-polarization beam and an S-polarization beam. U.S. Pat. No. 6,122,103 discloses a method for fabricating a metallic polarizer, which uses a semiconductor lithography technique to fabricate nano-scale metallic stripes on a transparent substrate so as to form a metallic polarizer.

### SUMMARY OF THE INVENTION

One aspect of the present invention provides a polarization beam source using a light-emitting device and a grating polarization beam splitter, in which light emitted from the light-emitting device is used to excite a fluorescent material to generate an unpolarized light and the grating polarization beam splitter is used to reflect a first polarization beam of the unpolarized light and allow a second polarization beam to transmit to the exterior of the polarization beam source.

The present polarization beam source comprises a reflective base, at least one light-emitting device positioned on the reflective base and configured to emit lights, a fluorescent material positioned on the light-emitting device to generate an unpolarized light under the irradiation of the lights and a polarization beam splitter configured to reflect a first polarization beam of the unpolarized light and allow a second polarization beam of the unpolarized light to transmit to the exterior of the polarization beam source.

Compared with conventional light-emitting devices capable only of outputting unpolarized light, the present invention employs a polarization beam splitter to reflect the first polarization beam of the unpolarized light and allow the second polarization beam of the unpolarized light to transmit to the exterior, i.e., the polarization beam source can selectively output the second polarization beam.

### BRIEF DESCRIPTION OF THE DRAWINGS

The objectives and advantages of the present invention will become apparent upon reading the following description and upon reference to the accompanying drawings in which:

FIG. 1 illustrates a conventional light-emitting device;

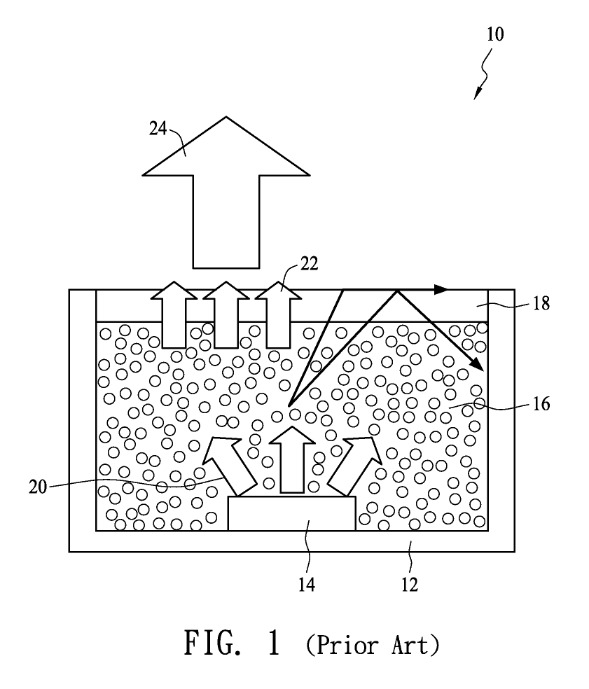

FIG. 2 illustrates a polarization beam source according to one embodiment of the present invention;

FIG. 3 illustrates the function of the grating polarization beam splitter and the omni-directional reflector according to one embodiment of the present invention;

FIG. 4 illustrates a transmittance spectrum of the omni-directional reflector for the S-polarization beam according to one embodiment of the present invention;

FIG. 5 illustrates a transmittance spectrum of the omni-directional reflector for the P-polarization beam according to one embodiment of the present invention;

FIG. 6 illustrates a transmission spectrum of the grating polarization beam splitter according to one embodiment of the present invention;

FIG. 7 illustrates a P/S ratio of the grating polarization beam splitter according to one embodiment of the present invention;

FIG. 8 illustrates the transmission/reflection spectrum of the combination of the grating polarization beam splitter and the omni-directional reflector for the P-polarization beam and S-polarization beam according to one embodiment of the present invention; and

FIG. 9 illustrates a polarization beam source according to another embodiment of the present invention.

### DETAILED DESCRIPTION OF THE INVENTION

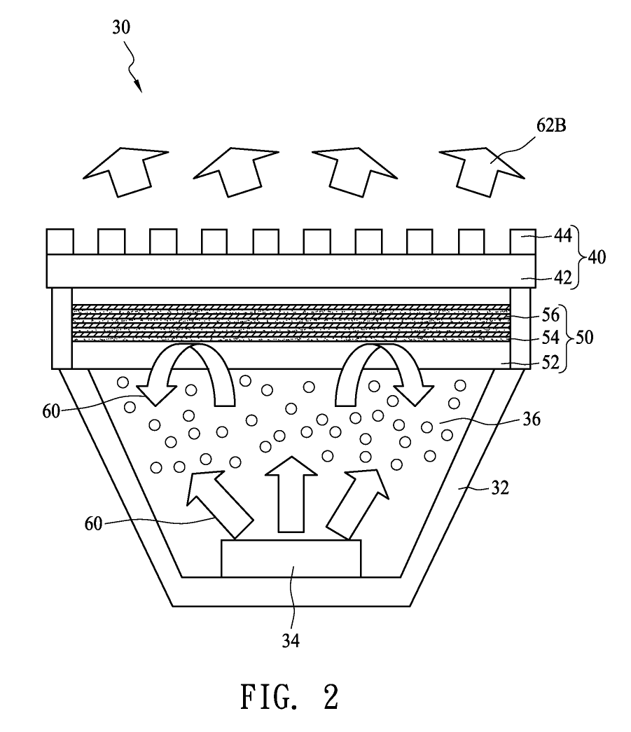

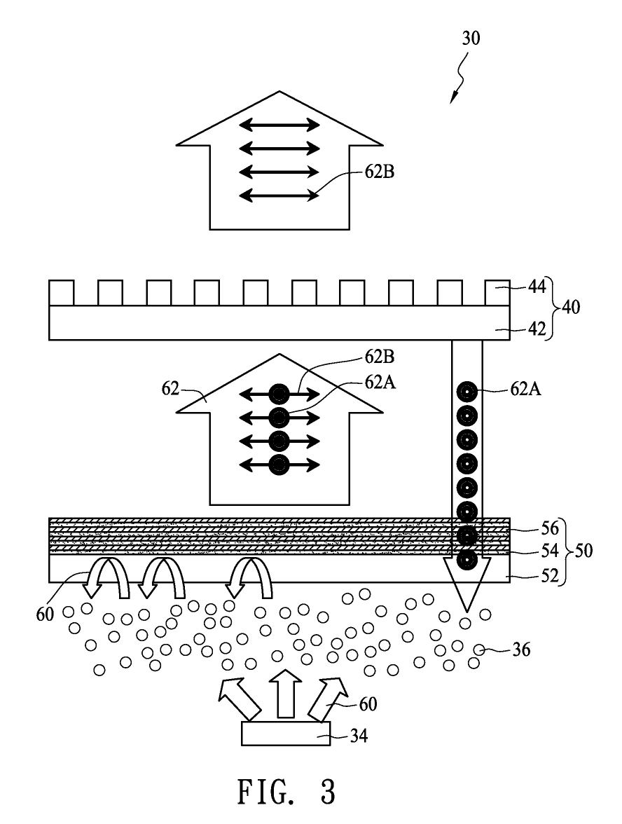

FIGS. 2 and 3 illustrate a polarization beam source 30 according to one embodiment of the present invention. The polarization beam source 30 includes a reflective base 32, at least one light-emitting device 34 (e.g. a light-emitting diode (LED) chip) positioned on the reflective base 32 and configured to emit ultraviolet light 60, a fluorescent material 36 positioned on the light-emitting device 34 to generate an unpolarized light 62, a grating polarization beam splitter 40 configured to reflect a first polarization beam 62A (e.g. a S-polarization beam) of the unpolarized light and allow a second polarization beam 62B (e.g. a P-polarization beam) of the unpolarized light 62 to transmit and an omni-directional reflector 50 positioned between the fluorescent material 36 and the grating polarization beam splitter 40. Particularly, the unpolarized light 62 generated by the fluorescent material 36 under the irradiation of the ultraviolet light 60 includes red, green and blue lights, which mix to form a white light.

The ultraviolet light 60 emitted from the light-emitting device 34 excites the fluorescent material 36 (e.g. yttrium aluminum garnet) to generate the unpolarized light 62 (e.g. the red, green, blue lights), which can pass through the omni-directional reflector 50. The reflective base 32 is preferably a metallic cup, the light-emitting device 34 is positioned at the bottom of the metallic cup, and the inner wall of the metallic cup is a reflecting surface (e.g. a metallic reflecting layer) for reflecting light to the fluorescent material 36. Furthermore, the polarization beam source 30 may include a plurality of light-emitting device 34 positioned on the reflective base 32.

The omni-directional reflector 50 includes a transparent substrate 52 and a plurality of first films 54 and second films 56 (which can be prepared using an optical coating technique) alternately laminated on the transparent substrate 52, wherein the refractive index of the first film 54 is larger than that of the second film 56. The transparent substrate 52 can be a glass substrate having a refractive index of 1.51 or a plastic substrate made of polycarbonate. The first film 54 can be made of material selected from the group consisting of titanium oxide, tantalum oxide, niobium oxide, cerium oxide and zinc sulphide, while the second film 56 can be made of material selected from the group consisting of silicon oxide, silicon nitride, aluminum oxide and magnesium fluoride.

The grating polarization beam splitter 40 includes a transparent substrate 42 and a plurality of line-shaped protrusions 44 positioned on the transparent substrate 42 to form a grating structure. The grating polarization beam splitter 40 can be fabricated by a lithography technique such as photolithography, E-beam lithography, holography or nano-imprinting (or microcontact). The transparent substrate 42 can be made of material selected from the group consisting of glass and plastic, and the line-shaped protrusion 44 includes metallic material such as gold, silver or aluminum. Preferably, the width of the line-shaped protrusions 44 ranges from 50 nm to 100 nm, the height ranges from 50 nm to 100 nm, and the pitch ranges from 100 nm to 200 nm. The line-shaped protrusions 44 are configured to reflect the first polarization beam 62A of the unpolarized light 62 and allow the second polarization beam 62B of the unpolarized light 62 to transmit.

Likewise, by changing the direction of the line-shaped protrusions 44, the line-shaped protrusions 44 can also be configured to reflect the second polarization beam 62B of the unpolarized light 62 and allow the first polarization beam 62A of the unpolarized light 62 to transmit. Furthermore, the pitch, height, and line width of the grating polarization beam splitter 40 can be adjusted to realize the tuning of the polarization operation range of the wavelength according to the present invention. Further, the structure of the line-shaped protrusions 44 can be zigzag, corrugated or semi-circular shaped for achieving the efficacy of polarization beam splitting.

The film design of the omni-directional reflector 50 is configured to selectively reflect the ultraviolet lights 60 emitted from the light-emitting device 34 to the fluorescent material 36, and to allow the unpolarized light 62 generated by the fluorescent material 36 to transmit. Therefore, the ultraviolet light beam 60 is confined inside the polarization beam source 30, so as to excite the fluorescent material 36 to generate unpolarized lights 62 as much as possible to improve the internal conversion efficiency, and prevent the ultraviolet lights 60 from passing through the omni-directional reflector 50 and propagating to the exterior of the polarization beam source 30.

The unpolarized light 62 includes the first polarization beam 62A and the second polarization beam 62B. The structure design of the line-shaped protrusion 44 of the grating polarization beam splitter 40 is configured to selectively reflect the first polarization beam 62A to the interior of the polarization beam source 30 and allows the second polarization beam 62B to transmit. The first polarization beam 62A reflected by the grating polarization beam splitter 40 is scattered by the fluorescent material 36 to be converted into an unpolarized light. The unpolarized light is then transmitted to the grating polarization beam splitter 40 to further provide the second polarization beam 62B.

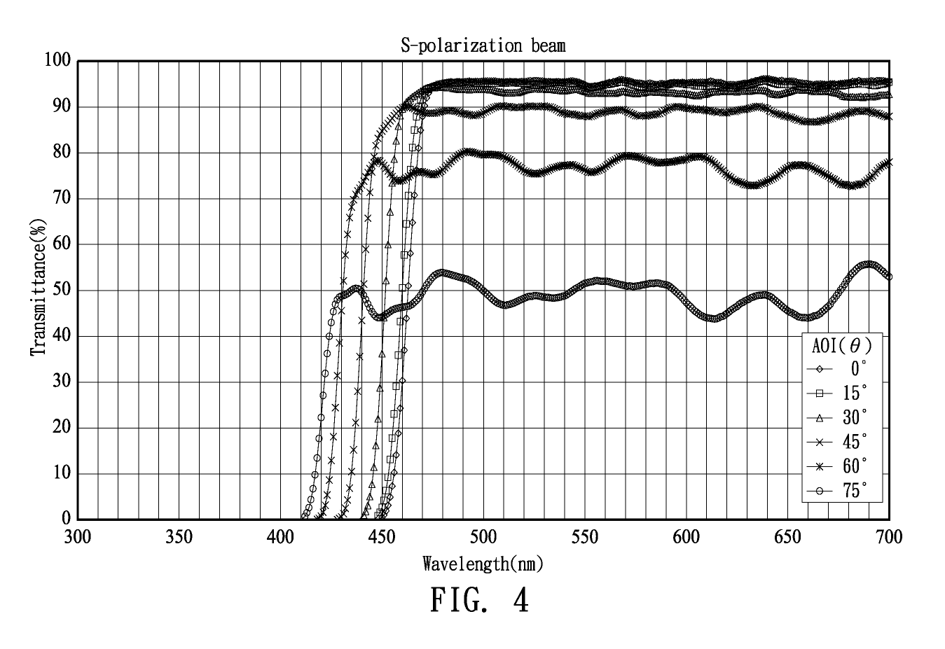

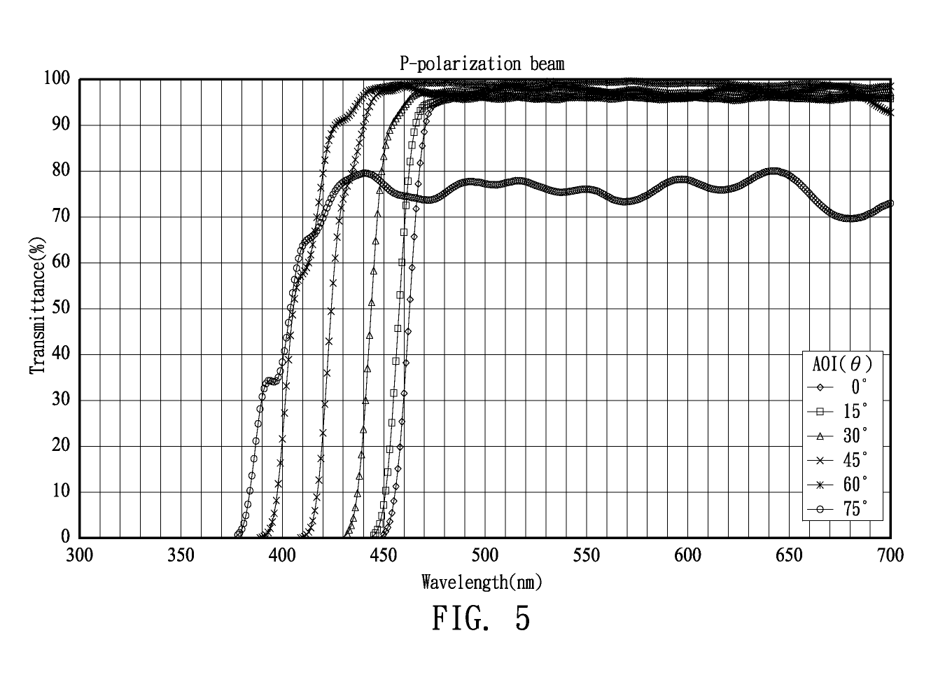

FIGS. 4 and 5 illustrate transmittance spectrums of the omni-directional reflector 50 according to one embodiment of the present invention. The omni-directional reflector 50 has a reflectance larger than 99% for S-polarization beams having a wavelength less than 410 nm and an incident angle between 0° and 75°. The omni-directional reflector 50 provides the same effect on P-polarization beams having a wavelength less than 390 nm and an incident angle between 0° and 75°. As a whole, the omni-directional reflector 50 provides a total internal reflection effect on incident light having wavelengths ranging from 359 nm to 448 nm, while incident light having wavelengths ranging from 450 nm to 700 nm has a higher transmission effect.

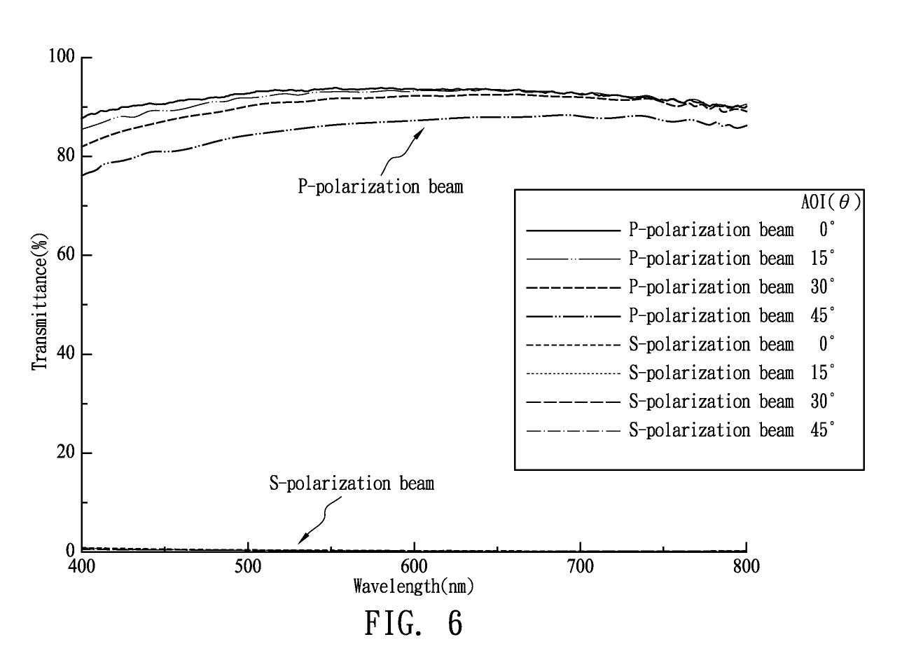

FIG. 6 illustrates a transmittance spectrum of the grating polarization beam splitter 40 according to one embodiment of the present invention. The transmittance of the grating polarization beam splitter 40 for P-polarization beams having wavelengths ranging from 430 nm to 680 nm (visible light) is larger than 90%. Comparatively, the transmittance of the grating polarization beam splitter 40 for S-polarization beams having wavelengths ranging from 430 nm to 680 nm is less than 0.4%. Particularly, if the incident light has wavelength in the visible light and an incident angle of 0, 15°, 30° or 45°, the transmittances of the P-polarization beams are all larger than 80% and the transmittances of the S-polarization beam are all less than 1%.

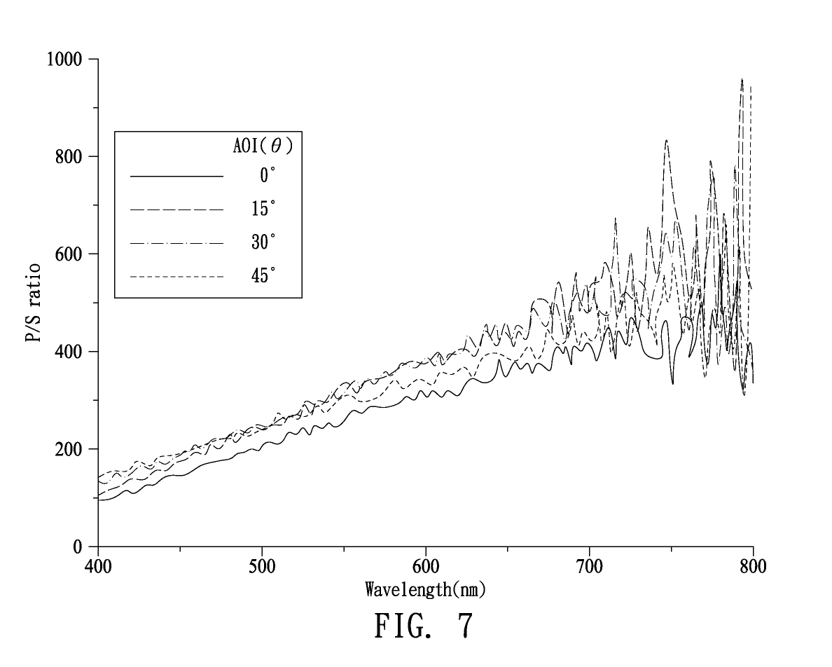

FIG. 7 illustrates the P/S ratio of the grating polarization beam splitter 40 according to one embodiment of the present invention. The P/S ratio is defined as:

P/S ratio=(the transmittance of the P-polarization beam/the transmittance of the S-polarization beam).

The P/S ratios of the grating polarization beam splitter 40 are all above 100, and even up to above 400 in the red waveband, and the incident angle has little impact on the P/S ratio.

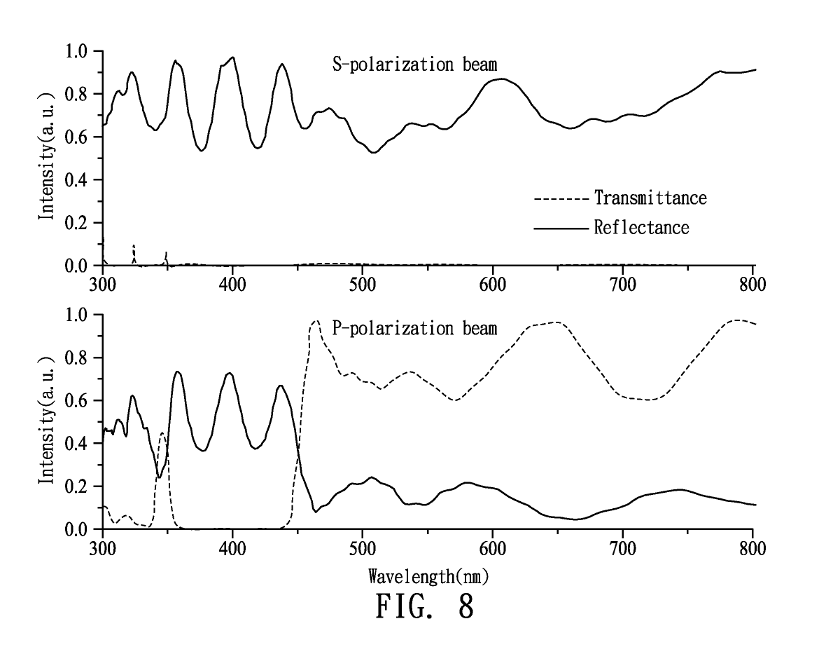

FIG. 8 illustrates the transmittance/reflectance spectrum of the combination of the grating polarization beam splitter 40 and the omni-directional reflector 50 for the P-polarization beam and S-polarization beam according to one embodiment of the present invention. The combination of the grating polarization beam splitter 40 and the omni-directional reflector 50 has a low transmittance and a high reflectance for P-polarization beams and S-polarization beams having wavelengths less than 430 nm, which is suitable for confining the ultraviolet lights 60 emitted from the light-emitting device 34 inside the polarization beam source 30.

Furthermore, the combination of the grating polarization beam splitter 40 and the omni-directional reflector 50 has a high transmittance and a low reflectance for P-polarization beams having wavelengths ranging from 430 nm to 680 nm (visible light), which is suitable for the output of the P-polarization beam. Comparatively, the combination of the grating polarization beam splitter 40 and the omni-directional reflector 50 has a transmittance nearly zero and a reflectance larger than 0.5 for S-polarization beams having wavelengths ranging from 430 nm to 680 nm (visible light), which is suitable for confining the S-polarization beam inside the polarization beam source 30.

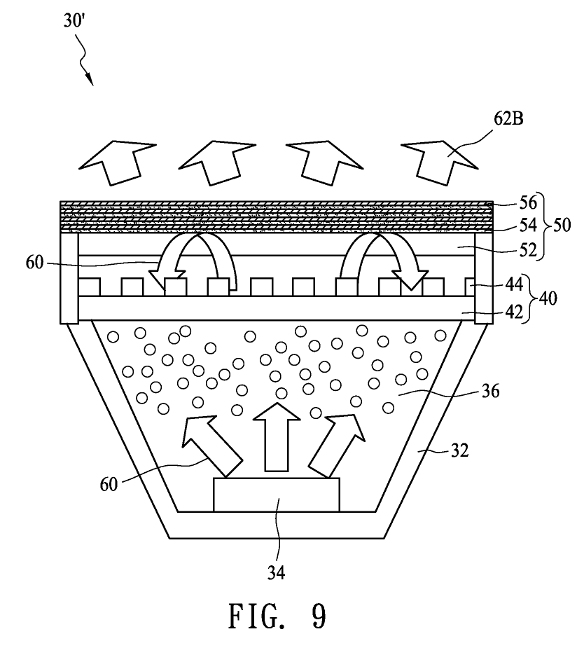

FIG. 9 illustrates a polarization beam source 30′ according to another embodiment of the present invention. Compared with the polarization beam source 30 shown in FIG. 2 having the omni-directional reflector 50 positioned between the fluorescent material 36 and grating polarization beam splitter 40, the polarization beam source 30′ in FIG. 9 has the omni-directional reflector 50 positioned above the grating polarization beam splitter 40 and separated from the grating polarization beam splitter 40 by an air gap, i.e. the positions of the grating polarization beam splitter 40 and the omni-directional reflector 50 interchange to form the polarization beam source 30′. Briefly, the omni-directional reflector 50 and the grating polarization beam splitter 40 are required to be positioned above the fluorescent material 36. Furthermore, the omni-directional reflector 50 can also be positioned on the upper and lower ends of the fluorescent material 36 to form a resonant cavity structure of the ultraviolet lights 60, and enhance the light conversion efficiency of the ultraviolet lights 60 and the unpolarized light 62.

Compared with conventional light-emitting devices 10 capable only of outputting unpolarized light 24, the present polarization beam source 30 employs a grating polarization beam splitter 40 to reflect the first polarization beam 62A of the unpolarized light 62 generated by the fluorescent material 36 and allow the second polarization beam 62B of the unpolarized light 62 to transmit such that the polarization beam source 30 can selectively output the second polarization beam 62B.

The above-described embodiments of the present invention are intended to be illustrative only. Numerous alternative embodiments may be devised by those skilled in the art without departing from the scope of the following claims.

What is claimed is:

1. A polarization beam source, comprising:
a reflective base;
at least one light-emitting device positioned on the reflective base and configured to emit lights;
a fluorescent material positioned on the light-emitting device to generate an unpolarized light under the irradiation of the lights; and
a polarization beam splitter configured to reflect a first polarization beam of the unpolarized light and allow a second polarization beam of the unpolarized light to transmit.

2. The polarization beam source as claimed in claim 1, wherein the polarization beam splitter comprises:
a first substrate; and
a plurality of line-shaped protrusions positioned on the first substrate.

3. The polarization beam source as claimed in claim 2, wherein the first substrate is made of material selected from the group consisting of glass and plastic.

4. The polarization beam source as claimed in claim 2, wherein the line-shaped protrusion comprises metallic material.

5. The polarization beam source as claimed in claim 2, wherein the line-shaped protrusion comprises metallic material selected from the group consisting of gold, silver and aluminum.

6. The polarization beam source as claimed in claim 2, wherein the width of the line-shaped protrusion ranges from 50 nm to 100 nm.

7. The polarization beam source as claimed in claim 2, wherein the height of the line-shaped protrusion ranges from 50 nm to 100 nm.

8. The polarization beam source as claimed in claim 2, wherein the pitch of the line-shaped protrusion ranges from 100 nm to 200 nm.

9. The polarization beam source as claimed in claim 2, wherein the plurality of line-shaped protrusions forms a grating structure.

10. The polarization beam source as claimed in claim 1, further comprising a reflector positioned above the fluorescent material.

11. The polarization beam source as claimed in claim 10, wherein the reflector comprises:
a second substrate; and
a plurality of first films and second films alternately laminated on the second substrate.

12. The polarization beam source as claimed in claim 11, wherein the second substrate is made of material selected from the group consisting of glass and plastic.

13. The polarization beam source as claimed in claim 11, wherein the refractive index of the first films is larger than that of the second films.

14. The polarization beam source as claimed in claim 11, wherein the first films are made of material selected from the group consisting of titanium oxide, tantalum oxide, niobium oxide, cerium oxide and zinc sulphide.

15. The polarization beam source as claimed in claim 11, wherein the second films are made of material selected from the group consisting of silicon oxide, silicon nitride, aluminum oxide and magnesium fluoride.

16. The polarization beam source as claimed in claim 10, wherein the reflector is positioned above the polarization beam splitter.

17. The polarization beam source as claimed in claim 10, wherein the reflector is positioned between the fluorescent material and the polarization beam splitter.

18. The polarization beam source as claimed in claim 1, wherein the reflective base is a metallic cup.

19. The polarization beam source as claimed in claim 18, wherein the inner wall of the metallic cup is a reflecting surface for reflecting lights to the fluorescent material.

20. The polarization beam source as claimed in claim 1, further comprising two reflectors positioned on two ends of the fluorescent material.
